(19) United States
(12) Patent Application Publication
(10) Pub. No.: US 2008/0292541 A1
(43) Pub. Date: Nov. 27, 2008

(54) Hydrogen Generating Agent and Use Thereof

(75) Inventors: Kensuke Kamada, Hiroshima (JP); Testuro Nakahama, Hiroshima (JP)

Correspondence Address: LUCAS & MERCANTI, LLP, 475 PARK AVENUE SOUTH, 15TH FLOOR, NEW YORK, NY, 10016, US

(73) Assignee: HIROMAITO CO. LTD., HIROSHIMA (JP)

(21) Appl. No.: 12/093,296

(22) PCT Filed: Nov. 2, 2006
(86) PCT No.: PCT/JP2006/321944

§ 371 Date: May 9, 2008

(30) Foreign Application Priority Data
Nov. 10, 2005 (JP) 2005-325659
Dec. 13, 2005 (JP) 2005-358411
May 9, 2006 (JP) 2006-130653
Jun. 12, 2006 (JP) 2006-161833

(51) Int. Cl. C01B 3/08; C09K 3/00; B28B 1/00

(52) U.S. Cl. 423/657; 252/182.32; 264/294

(57) ABSTRACT

An easy-to handle hydrogen generating agent has been invented in which a hydrogen compound such as alkali metal hydrides, alkali earth metal hydrides and metal borohydride salts is embedded in a water-soluble solid compound such as a polyethylene glycol and organic acid. The hydrogen generating agent dissolves in water to slowly generate hydrogen gas. The oxidation-reduction potential of the water that has dissolved the hydrogen generating agent is shifted to the reducing side remarkably; therefore, the hydrogen generating agent can be used for preparation of cosmetics, beverage and bath water having reducibility. Also, the generated hydrogen can be used as a fuel for a fuel cell.

### TECHNICAL FIELD

The present invention relates to a hydrogen generating agent composed of a metal hydride or a metal borohydride salt. The hydrogen generating agent is reacted with water to generate hydrogen, and the hydrogen is dissolved in an aqueous composition. The hydrogen generating agent is used for preparation of, for example, cosmetics, beverage water and bath water having reducibility, and the generated hydrogen is used as a fuel for a fuel cell.

### BACKGROUND ART

It is known that the oxidation-reduction potential (hereinafter referred to as ORP) of water shifts to the reducing side when a hydrogen gas is dissolved in water. Patent Document 1 reports that such reducing water or a reducing aqueous composition is antioxidant, drinking of reducing water or reducing aqueous compositions physiologically contributes to health through elimination of active oxygen and skin care products such as skin lotions containing reducing water or reducing aqueous compositions prevent skin aging. Patent Document 2 discloses a technique for preventing skin aging and promoting blood circulation through bathing in reducing water containing carbon dioxide.

As techniques for generating a hydrogen gas, Patent Document 3 discloses a technique for reacting a magnesium metal with water to generate hydrogen to prepare reducing water so as to achieve the above effects, Patent Document 4 discloses a technique for reacting calcium hydride, which is used as the hydrogen source for a fuel cell, with water vapor through a water-repellent diaphragm, Patent Document 5 discloses a technique for reacting an alkaline earth metal hydride with a solution containing an acid and water, and Patent Document 6 discloses a technique for mixing powder such as metal borohydride salt with a thermoplastic resin powder such as polyethylene to form a compression molding, and reacting the molding with acidic water while shaving the surface of the molding thereby generating hydrogen.

Patent Document 1: Japanese Patent Application Laid-Open No. 2000-119161

Patent Document 2: Japanese Patent Application. Laid-Open No. 2000-308891

Patent Document 3: Japanese Patent Application Laid-Open No. 2004-041949

Patent Document 4: Japanese Patent Application Laid-Open No. 2004-269323

Patent Document 5: Japanese Patent Application Laid-Open No. 2002-080201

Patent Document 6: Japanese Patent Application Laid-Open No. 2003-146604

### DISCLOSURE OF THE INVENTION

### Problems to be Solved by the Invention

A hydrogen gas is very slightly soluble in water. The inventors have found that the slightly dissolved hydrogen gas remarkably shifts the ORP of water to the reducing side thereby generating reducing water, and the generated hydrogen gas is useful as a fuel for a fuel cell, and aimed to develop a hydrogen generating agent which reacts with water to generate hydrogen.

Examples of known substances which react with water to generate a hydrogen gas include, as described in Background Art, a magnesium metal, alkaline earth metal hydride such as magnesium hydride, and metal borohydride salts such as sodium borohydride. A magnesium metal reacts with water or acidic water to generate hydrogen. However, the reaction is not suitable for practical use because the reaction rate is so low. The use of magnesium hydride or sodium borohydride as a hydrogen generating agent for a fuel cell requires acidic water for increasing the reaction rate. In addition, these hydrogen compounds for increasing the reaction rate are fine powder and hygroscopic, so that they are difficult to handle.

On the other hand, calcium hydride and lithium hydride rapidly react with water, and generate hydrogen upon contact with water instantaneously. Therefore, they cannot be used as they are. Sodium borohydride also rapidly reacts with acidic water, so that it is difficult to control the rate of hydrogen generation. A problem to be solved by the present invention is to provide a practical hydrogen generating agent which retards the reaction rate of a hydrogen compound which rapidly reacts with water. Another problem to be solved by the present invention is to provide a hydrogen generating agent which is capable generating hydrogen using neutral water even if the hydrogen compound requires acidic water for generating hydrogen. Another problem to be solved by the present invention is to provide a hydrogen generating agent which is easy to handle.

### Means for Solving the Problem

The above-described problems are solved by a hydrogen generating agent composed of at least one hydrogen compound selected from alkali metal hydrides, alkali earth metal hydrides and metal borohydride salts embedded in a water-soluble solid compound or a mixture of water-soluble solid compounds. The water-soluble compound is preferably a polymer compound, and particularly preferably a polyethylene glycol. The mixture of the water-soluble compounds preferably contains an acid. The hydrogen generating agent is preferably in the form of tablets.

Applications of the hydrogen generating agent include a bath agent composed of the hydrogen generating agent. By dissolving the hydrogen generating agent in water or an aqueous composition, there is provided reducing water or a reducing aqueous composition. There is also provided a method for generating hydrogen by reacting the hydrogen generating agent with water or an aqueous composition to generate hydrogen.

### ADVANTAGEOUS EFFECT OF THE INVENTION

When a hydrogen compound such as calcium hydride, lithium hydride, or sodium borohydride is embedded in a water-soluble solid compound such as a polyethylene glycol, the reaction between the hydrogen compound and water or acidic water proceeds slowly. When a solid acid is contained in the water-soluble compound, a hydrogen compound such as magnesium hydride or sodium borohydride is dissolved in neutral water to effectively generate hydrogen.

The hydrogen generating agent of the present invention may be formed in arbitrary shapes, such as tablet, block, pellet, granule, or powder, and thus is easy to handle. When the hydrogen generating agent of the present invention is used in cosmetics, beverage water, or bath agents, it readily imparts reducibility to these aqueous compositions.

### BEST MODE FOR CARRYING OUT THE INVENTION

Examples of the alkali metal hydride used in the present invention include lithium hydride (LiH), sodium hydride (NaH) and potassium hydride (KH). Among these compounds, LiH is preferable because it is relatively stable in air. Examples of the alkali earth metal hydride include magnesium hydride (MgH₂), calcium hydride (CaH₂), barium hydride (BaH₂), beryllium hydride (BeH₂) and strontium hydride (SrH₂). Among these compounds, MgH₂ and CaH₂ are preferable because they are relatively stable in air.

The metal borohydride salt used in the present invention is expressed by a general formula MBH4, wherein M represents an alkali metal such as lithium, sodium, potassium, or rubidium. Among these metal salts, the sodium salt (sodium borohydride, hereinafter abbreviated as SBH) is preferable in terms of safety and cost. These hydrogen compounds may be used alone or in combination.

An alkali metal hydride (MH) reacts with water to generate hydrogen as expressed by the chemical formula 1 (M represents an alkali metal).

MH+H₂O→H₂+M(OH) [Chemical formula 1]

An alkali earth metal hydride reacts with water to generate hydrogen as expressed by the chemical formula 2 (M represents an alkaline earth metal) and a metal borohydride salt (M represents an alkali metal) reacts with water to generate hydrogen as expressed by the chemical formula 3.

MH₂+2H₂O→2H₂+M(OH)₂ [Chemical formula 2]

MBH₄+2H₂O→4H₂+MBO₂ [Chemical formula 3]

The inventors examined producing reducing water by dissolving a hydrogen gas generated by these reactions in water thereby decreasing the ORP of water. However, LiH and CaH₂ violently react with water and start to react upon contact with water instantaneously. Therefore, when a CaH₂ powder (commercially available CaH₂ is a fine powder composed of aggregated submicron fine particles as observed with a microscope) is added to the water surface, a violent reaction proceeds and powder scatters in air.

In order to moderate the violent reaction between water and the hydrogen compound, the inventors examined embedding a hydrogen compound in a water-soluble solid compound. According to the examined process, a hydrogen compound is embedded in a water-soluble compound, and the water-soluble compound dissolves first upon contact with water, and then the embedded hydrogen compound such as CaH₂ reacts with water. Surprisingly, the idea was proved true. The reaction between a hydrogen compound and water was moderated just by dispersing the hydrogen compound powder in a water-soluble compound and solidifying the mixture, which allowed efficient dissolution of the generated hydrogen gas. In addition, the rate of hydrogen generation was so slow that the hydrogen gas was expected to be useful as a fuel for a fuel cell.

On the other hand, other hydrogen compound such as MgH₂ or a metal borohydride salt slowly or scarcely reacts with neutral water. In order to solve the problem, the inventors used a solid acid as a water-soluble compound, dispersed a hydrogen compound in the water-soluble compound, and solidified the mixture. As a result of this, the hydrogen generating agent efficiently generated a hydrogen gas when dissolved in neutral water.

The water-soluble compound referred to in the present invention is a solid substance and soluble in water at room temperature. The water-soluble compound may be composed of a single component or mixed components, and may be a polymer compound or low molecular weight compound. The polymer compound is a water-soluble polymer, and examples thereof include synthetic polymers such as a polyethylene glycol (hereinafter abbreviated as PEG), polyvinyl alcohol, polyvinyl pyrrolidone, polyacrylamide, polyacrylic acid, polymethacrylic acid and salts thereof. Examples of natural polymers include starch, dextrin, carrageenan, guar gum and xanthan gum Examples of semisynthetic polymers include cellulose derivatives such as methyl cellulose, hydroxyethylmethyl cellulose, hydroxypropylmethyl cellulose, carboxymethyl cellulose and salts thereof.

Examples of low molecular weight compounds include monosaccharides such as xylose, xylitol, glucose, glucitol, fructose and mannose, oligosaccharides such as sucrose, maltose, trehalose and raffinose, cyclodextrin, caramel-like matters prepared by melting a monosaccharide or oligosaccharide at a high temperature, and amino acids such as glutamic acid, asparatic acid and salts thereof. Other examples are inorganic salts such as carbonates such as sodium bicarbonate and sodium carbonate, sodium chloride, sodium sulfate, sodium nitrate and sodium borate. Among these water-soluble compounds, polymer compounds, in particular PEG is a preferable embedding agent for the below-described reason. Among the low molecular weight compounds, organic compounds are preferable embedding agents.

In order to efficiently dissolve a hydrogen gas in water thereby preparing a reducing aqueous composition, it is preferable that the hydrogen generating agent react with water while being submerged in water. For this purpose, it is preferable that a high density inorganic salt such as sodium sulfate be added as an additive during embedding of a hydrogen compound in a water-soluble compound.

On the other hand, the hydrogen compound expressed by the chemical formula 1 or 2 reacts with water to generate a metal hydroxide, so that a solution of the aqueous composition is alkaline. Accordingly, when a neutral or weakly acidic reducing aqueous composition is to be prepared, it is preferable that an acid be added to the water-soluble compound. Other hydrogen compound such as MgH₂ or SBH requires an acid for proceeding the reaction. Also in this case, it is preferable that an acid be added to a water-soluble compound during preparation of the hydrogen generating agent.

The acid is a solid acid, and may be composed of a single component or mixed components. Examples of organic acids include carboxylic acids such as fumaric acid, maleic acid, maleic anhydride, succinic acid, succinic anhydride, tartaric acid, malic acid, citric acid, oxalic acid and malonic acid, ascorbic acid, various derivatives thereof, polymeric carboxylic acids such as polyacrylic acid and polymethacrylic acid and amino acids such as glutamic acid. Examples of inorganic acids include sulfamic acid, boric acid, metaboric acid and boron oxide.

In cases where a neutral reducing aqueous composition is to be obtained, an acid is added to the water-soluble compound in an amount enough for neutralizing the base generated by the reaction between the hydrogen compound and water. When the amount of the acid is different from the amount necessary for neutralizing the base, the resultant reducing aqueous composition is weakly acidic or weakly alkaline. Such reducing compositions can be thus prepared. When other hydrogen compound such as MgH₂ or SBH is used, the stronger the acidity, the higher the generation rate of the hydrogen gas. Accordingly, as necessary, the amount of the acid may be larger than the amount necessary for neutralizing the base. Even if the hydrogen generating agent contains an acid in an amount necessary for neutralization, in consideration of the process of dissolution of the agent in water, the pH of the region containing the hydrogen generating agent is considered lower than the pH of the whole water achieved after the agent is dissolved and neutralized. It is considered that hydrogen is more efficiently generated in comparison with the case where a hydrogen compound is directly dissolved in acidic water containing an acid in an amount necessary for neutralization (see the case of MgH₂ in Example 26).

The embedded state referred to in the present invention is a state wherein a hydrogen compound powder is dispersed and held in a water-soluble compound. A preferable embedded state is a state wherein islands of the hydrogen compound powder is dispersed and held in a sea of water-soluble compound. The ratio between the sea and islands varies depending on the mixing ratio between the hydrogen compound and the water-soluble compound. The mixing ratio of the hydrogen compound embedded in the water-soluble compound is preferably from 0.1 to 50% by mass, and more preferably from 0.5 to 30% by mass. If the content is 0.1% or less by mass, the amount of hydrogen generation is so small that a large amount of the hydrogen generating agent of the present invention must be dissolved in water. If the content is more than 50% by mass, the powder of the hydrogen compound is dispersed in the water-soluble compound not in island shape but aggregates in large regions, and the hydrogen generating agent rapidly reacts with water.

A few methods for embedding the hydrogen compound powder in a water-soluble compound are described below. Whichever method is used, the water-soluble compound as the embedding agent is preferably dehydrated and dried in advance. If any moisture remains, the hydrogen compound reacts with the moisture, so that much of the hydrogen compound in the resultant hydrogen generating agent is deactivated.

The first embedding method is a melting embedding method. A crystalline water-soluble compound having a melting point is molten by being heated to a temperature above the melting point thereof, and stirred together with a hydrogen compound powder. As necessary, a powdery acid or inorganic salt is further added to the mixture, uniformly dispersed in the melt, and cooled to be solidified. PEG having a molecular weight of 1000 or more is preferred as a water-soluble compound for embedding the hydrogen compound powder, because it is solid at room temperature, and has a low melting point in the vicinity of 65° C. The melt viscosity of a PEG increases with the increase in its molecular weight. Therefore, PEG having a molecular weight of 20000 or less is preferable.

When such a polymer compound is used, the melt containing the hydrogen compound can be extrusion-molded into strands using appropriate molding equipment. The strands can be cut into pieces of appropriate length thereby forming pellets of the hydrogen generating agent. The pellets can be easily formed into granules or powder using an appropriate mill. The melt can be easily injected into an optional die to be shaped into blocks or rods of any form.

The second embedding method is a solution embedding method. A water-soluble compound is dissolved in an organic solvent, which will not react with the hydrogen compound, to make a solution, and stirred together with a hydrogen compound powder to make a mixed solution. The solution is shaped into a film or fibers using appropriate molding equipment, and the solvent is dried and removed. In cases where the water-soluble compound is a polymer compound, the mixed solution is added to a polymer nonsolvent which will not react with the hydrogen compound, the polymer including the hydrogen compound is precipitated, and then the precipitate is dried. The second method uses an organic solvent, and thus requires dehydration and drying of the solvent, and gives a heavy environment load. In this regard, the first melting embedding method is more preferable.

The third embedding method is a compression molding method. A powdery hydrogen compound and a powdery or granular water-soluble compound are uniformly mixed, and formed into pellets or tablets using an appropriate compression molding equipment. In the method, in order to strongly disperse and keep the powdery hydrogen compound in the water-soluble compound, it is desirable to use a water-soluble compound which serves as a binding agent, and the above-described polymer compound or organic compound as the embedding agent. The pressure during compression molding is preferably from 0.5 to 20 ton/cm². If the pressure is too low, the molding tends to be collapsed with moisture absorption and the like, and if the pressure is too high, longer times are required for dissolving the molding in water, or for generating hydrogen.

The size of the molding can be changed from several millimeters to several centimeters by changing the size of the jig for packing the powder during molding. The compression molding method requires two step including mixing and compression of the powder. Different from the melting embedding method, the compression molding method includes no heating step, so there is no concern about heat decomposition of the mixed components. Accordingly, the compression molding method is preferred for the production of a hydrogen generating agent having such components.

In another method, a hydrogen generating agent prepared by the melting embedding method or the solution embedding method is pulverized to powder, and mixed with other powdery water-soluble compound as an additive, and the mixture is formed into tablets by the compression molding method. In the method, the additive is not exposed to heat or organic solvents used in an embedding method. Therefore, the method is preferred for preparation of a hydrogen generating agent containing an additive susceptible to the environment.

Preparation of reducing water or a reducing aqueous composition (hereinafter reducing water is also referred to as a reducing aqueous composition) using the hydrogen generating agent of the present invention is described below. The ORP of tap water (in the present invention, ORP is based on standard electrode potential, and expressed in mV) is about 800 mV, and the ORP of purified water (tap water treated with activated carbon, ion exchange resin and microfiltration) is about 400. It is known that the ORP decreases with the increase in the pH. A reducing aqueous composition referred to in the present invention is an aqueous composition which exhibits a lower ORP than purified water when compared at the same pH. As shown by Examples, a reducing aqueous composition is prepared just by dissolving several ppm of a hydrogen compound in tap water or purified water.

An aqueous composition referred to in the present invention is a composition containing water preferably at a ratio of 50% by mass or more. Examples of aqueous compositions include water containing an acid or alkali, cosmetics such as skin lotions, beauty essences, milky lotions, creams and face pack gels containing various moisture retention components and/or whitening components, beverages containing amino acids and minerals, bath water and detergents. When the hydrogen generating agent of the present invention is added to these aqueous compositions, being dissolved in water, reducing aqueous compositions are readily prepared.

A low-viscosity cosmetic such as a skin lotion is often packed in an aerosol can together with a nitrogen gas or liquefied gas as an injection gas. In the first place, the hydrogen generating agent of the present invention is injected in an aerosol can and a skin lotion is injected from the top of the can, and an injection gas is added under pressure. The can is sealed, and thus a reducing skin lotion is readily produced. The container may not be an aerosol can. Through the use of the hydrogen generating agent of the present invention, a hydrogen gas can be directly dissolved in a cosmetic in the container of the final product. Therefore, different from a production method involving dissolution of a hydrogen gas at an intermediate stage, the present method will not cause dissipation of a hydrogen gas, and provides a cosmetic having high reducibility.

In cases where the hydrogen generating agent of the present invention contains no acid, as described above, the reducing aqueous composition generated by the reaction between the agent and water is alkaline. This presents no problem for detergents or other applications which can have strong alkalinity. On the other hand, the composition is preferably neutral to weakly acidic for cosmetics and the like. For such applications, an acid is added to the alkaline reducing aqueous composition, or an acid is added to the aqueous composition to make a weak acid, and then a hydrogen generating agent is added. In this case, the acid may be in liquid state, and may be an inorganic acid. The above-described various organic acids are suitable for applications involving contact with human body.

Weakly acidic carbonated water promotes blood circulation under the skin, and it is thus used in beverage water, cosmetics and bath agents. When carbonic acid or carbon dioxide is used for adjusting the pH of the reducing aqueous composition to weakly acidic or neutral, the resultant reducing aqueous composition contains carbon dioxide. The reducing aqueous composition containing carbon dioxide serves as a skincare aqueous composition which is more effective for preventing skin aging. When the hydrogen generating agent contains MgH₂ or SBH as a hydrogen compound, the above-described skincare aqueous composition is readily produced through the use of carbonated water as acidic water.

When a weakly acidic reducing aqueous composition is prepared using carbonic acid, carbonic acid may be added before or after, or simultaneously with the addition of the hydrogen generating agent. In order to contain carbonic acid in an aqueous composition, carbon dioxide may be directly dissolved in the aqueous composition, or carbon dioxide generated by reaction between a carbonate or bicarbonate and an organic acid may be dissolved in the aqueous composition. In the latter case, these compounds as additives are mixed with a hydrogen compound, and the mixture is embedded in an embedding agent to make a hydrogen generating agent. When the hydrogen generating agent is dissolved in an aqueous composition, hydrogen and carbon dioxide are generated simultaneously. Therefore, it is preferable that the content ratio between the carbonate or bicarbonate and the organic acid be adjusted such that the pH of the solution is weakly acidic. The hydrogen generating agent is suitable as a bath agent as described below.

The hydrogen generating agent of the present invention formed into granules or tablets may be added into a bathtub to serve as a bath agent. As shown by the following example, when hydrogen compound is added to a tap water at a ratio of several milligrams per liter, the ORP decreases by several hundreds millivolts. The higher the loading, the ORP decreases, but the preferable reducibility of bath water is from −100 to 400 mv. If the ORP is −100 mv or less, the strong reducibility deteriorates rubber or other materials composing the bathtub. If the ORP is 400 mv or more, the reducibility is too weak.

With the increase in the loading of the hydrogen compound, the concentration of the generated metal hydroxide increases, and the pH of the bath water becomes alkaline. The pH range preferred for human body is considered between 4.5 and 10. In order to prepare a bath agent having a preferred pH, an organic acid or the like usually used in the carbonated bath agent may be added as a water-soluble compound to the hydrogen generating agent. The properties of tap water vary depending on the water source. In order to achieve a constant pH after dissolving the bath agent, it is preferable that a pH buffering agent or a pH adjusting agent be added to the hydrogen generating agent during preparation of the bath agent.

The bath agent may contain known additives besides the above-mentioned water-soluble compound. Examples of additives include crude drugs such as orange peel, mint leaves, saffron, camomile and rosemary, higher and polyhydric alcohols such as cetyl alcohol, stearyl alcohol, glycerol and sorbitol, fatty acid esters such as myristyl lactate, isopropyl myristate and isopropyl palmitate and natural oils such as jojoba oil, avocado oil and olive oil.

Other examples include, but not limited to, nonionic surfactants such as glycerol fatty acid esters, propylene glycol fatty acid esters and a polyethylene glycol fatty acid esters, fungicidal preservatives, sequestering agents, dyes and fragrant materials. Although some of these components are oil components insoluble in water, they are added in small amounts without impairing the effect of the present invention. These oil components are preferably emulsified and dispersed in water, or adsorbed to a water-soluble porous substance to make a bath agent. Many of these additives are readily decomposed by heat, so that the preparation of the bath agent is preferably conducted by the compression molding method or a combination of the compression molding method and melting embedding method.

The hydrogen generating agent of the present invention reacts with water to generate a hydrogen gas in accordance with the chemical formulae 1 to 3. The hydrogen gas slightly dissolves in water to form the reducing aqueous composition, but the major part of the gas vaporizes from water. The vaporized hydrogen is highly pure and useful for various applications. One of them is a fuel for a fuel cell. In a fuel cell, a fuel electrode and an air electrode are opposed to each other with an electrolyte sandwiched between them. Hydrogen is fed to the fuel electrode, and air or oxygen is fed to the air electrode, respectively, and electrons are given and received between these electrodes thereby generating electricity. The hydrogen generating agent of the present invention is useful as the hydrogen gas fed to the fuel electrode.

The hydrogen generating agent of the present invention generates hydrogen if only there is water. Since the hydrogen generating agent is embedded in a polymer compound or the like, it is safe and easy to handle. For example, a small hydrogen generating apparatus can be built from a container filled with the hydrogen generating agent in powder form and a container filled with water. Small fuel cells are required for charging batteries of cellular telephones and PCs. For such applications, the hydrogen generating agent of the present invention is considered suitable.

The present invention is further described below with reference to the following examples, but the technical scope of the present invention is not limited to these examples. The ORP used in the examples was measured by an ORP meter (manufactured by Toko Chemical Laboratories). The CaH₂ reagent was a powder having a size of 0 to 2 mm and a purity of 90 to 95% (manufactured by SIGMA-ALDRICH), LiH was a powder prepared by pulverizing first-class blocks having a purity of 98% or more (manufactured by Wako Pure Chemical Industries, Ltd.) in a mortar, MgH₂ was a powder having a purity of 98% (manufactured by Alfa Aescar), and NaBH₄ was a powder having a purity of 98% or more (manufactured by Hayashi Pure Chemical Ind., Ltd.) LiBH₄ was a powder having a purity of 90% or more (manufactured by Wako Pure Chemical Industries, Ltd.), and KBH₄ was a powder having unknown purity (manufactured by Wako Pure Chemical Industries, Ltd.). The PEG was a powder having a molecular weight of 13000 (manufactured by Sanyo Chemical Industries, Ltd.), unless otherwise noted. In the examples, calculations of the composition and the like are on the basis of the supposition that the purity of these hydrogen compounds is 100%. Percentages are % by mass unless otherwise noted.

### EXAMPLE 1

10 g of flakes of a PEG having a molecular weight of 20000 was placed in an aluminum dish, and heated and molten on a hot plate (surface temperature: about 125° C.). A predetermined amount of a CaH₂ reagent powder was added to and dispersed in the molten PEG under stirring with a spoon. After the powder was uniformly dispersed, the aluminum dish was removed from the hot plate, and cooled at room temperature (hereinafter the preparation method is referred to as a melting embedding method). The blocks of the solidified PEG including a CaH₂ powder were pulverized to make granules having a diameter of 1 to 5 mm. In this way, two hydrogen generating agents containing CaH₂ at ratios of 100 mg (referred to as hydrogen generating agent A; charge proportion of CaH₂: 1%) and 500 mg (referred to as hydrogen generating agent B; charge proportion of CaH₂: 5%) were prepared.

### EXAMPLE 2

90 ml of purified water was placed in a glass container, and a predetermined amount of the hydrogen generating agent A prepared in Example 1 was added from the top of the container, and then the container was immediately closed. The hydrogen generating agent dissolved in several minutes while moderately generating bubbles (hydrogen) on the water surface. For comparison, a predetermined amount of the CaH₂ powder was weighed and placed in a 1.5-L, PET bottle, 1.5 L of purified water was rapidly injected into the bottle, and then the bottle was immediately closed. In this case, the CaH₂ powder rapidly reacted with water upon injection of purified water, and the CaH₂ powder dispersed in air in the PET bottle.

The ORP and pH of the reducing water prepared as described above are summarized in Table 1. For easy comparison, the loading of CaH₂ was converted into the loading for 1 L of purified water, and the loading of the hydrogen generating agent was converted into the loading of CaH₂ (For example, 1 g of the hydrogen generating agent A is converted into 10 mg of CaH₂.) The results summarized in Table 1 indicate that the hydrogen generating agent A (CaH₂: 111 mg) more remarkably reduces the ORP than the direct addition of CaH₂ (133 mg).

### [Table 1]

TABLE 1
Loading of calcium hydride, and ORP and pH of
purified water

| Hydrogen | Loading | | |
|---|---|---|---|
| generating | (CaH2) | ORP | |
| agent | (mg/L) | (mv) | pH |
| None | 0 | 480 | 6.92 |
| (purified water) | | | |
| A | 111 | −87 | 11.79 |
| A | 222 | −152 | 12.07 |
| CaH2 | 33 | 106 | 11.26 |
| CaH2 | 67 | 75 | 11.66 |
| CaH2 | 133 | 51 | 11.95 |

### EXAMPLE 3

2 L of tap water was placed in a 2-L PET bottle, a predetermined amount of the hydrogen generating agent B prepared in Example 1 was added into the upper space of the bottle, and then the bottle was immediately tightly closed. The hydrogen generating agent B floated on the water surface, and dissolved in several minutes while generating bubbles. The ORP and pH of the tap water are summarized in Table 2 in the same manner as Table 1.

### [Table 2]

TABLE 2
Loading of calcium hydride, and ORP and pH of
tap water

| Hydrogen | Loading | | |
|---|---|---|---|
| generating | (CaH2) | ORP | |
| agent | (mg/L) | (mv) | pH |
| None | 0 | 800 | 7.40 |
| (tap water) | | | |
| B | 2 | 169 | 8.87 |
| B | 5 | 93 | 9.75 |
| B | 7 | 50 | 9.84 |

### EXAMPLE 4

Carbon dioxide was dissolved in purified water to make carbonated water having a pH of 4.20. 450 ml of the carbonated water was poured in a 500-ml PET bottle, a predetermined amount of the hydrogen generating agent B prepared in Example 1 was added, and then the bottle was tightly closed. The hydrogen generating agent dissolved in several minutes while violently generating bubbles. The ORP and pH of the obtained reducing water are summarized in Table 3. The solution prepared with 100 mg of CaH₂ was slightly turbid because the generated calcium carbonate was not completely dissolved, and the solution prepared with 200 mg of CaH₂ contained a small amount of white sediment on the bottom of the bottle. The other solutions were clear and colorless.

### [Table 3]

TABLE 3
Loading of calcium hydride, and ORP and pH of
carbonated water

| Hydrogen | Loading | | |
|---|---|---|---|
| generating | (CaH2) | ORP | |
| agent | (mg/L) | (mv) | pH |
| None | 0 | 592 | 4.20 |
| (carbonated water) | | | |
| B | 25 | 122 | 5.13 |
| B | 50 | −98 | 5.68 |
| B | 100 | −211 | 5.89 |
| B | 200 | −297 | 6.24 |

### EXAMPLE 5

A skin lotion was prepared from the following ingredients.

Ingredients of skin lotion

| | |
|---|---|
| Glycerol | 2.5% |
| Glycosyltrehalose | 1.2 |
| Trehalose | 1.0 |
| Serine | 1.0 |
| Disodium ascorbyl sulfate | 1.0 |
| Hydrolyzed hydrogenated starch | 0.8 |
| Methylparabene | 0.1 |
| Purified water | Remainder |

The skin lotion had a pH of 5.77. Several milliliters of a citric acid aqueous solution (0.1 mol/l) was added to adjust the pH to 4.13. 100 g of the skin lotion after pH adjustment was placed in a glass container, and a predetermined amount of the hydrogen generating agent B prepared in Example 1 was added to the skin lotion, and the container was tightly closed. The hydrogen generating agent dissolved in several minutes while generating bubbles. The pH and ORP of the skin lotion after dissolution of the hydrogen generating agent are summarized in Table 4.

### [Table 4]

TABLE 4
Loading of hydrogen generationg agent B, and ORP
and pH of skin lotion

| Hydrogen | | | |
|---|---|---|---|
| generating | Loading | | |
| agent | (CaH2) | ORP | |
| (g) | (mg/Kg) | (mv) | pH |
| 0 | 0 | 543 | 4.13 |
| 0.1 | 50 | −74 | 4.66 |
| 0.2 | 100 | −104 | 5.11 |
| 0.3 | 150 | −182 | 6.84 |

### EXAMPLE 6

A face pack gel containing dissolved carbon dioxide was prepared from the following ingredients.

Ingredients of face pack

| | |
|---|---|
| Methyl cellulose | 3.0% |
| Glycerol | 2.5 |
| Glycosyltrehalose | 1.2 |
| Serine | 1.0 |
| Raffinose | 1.0 |
| Disodium ascorbyl sulfate | 0.8 |
| Hydrolyzed hydrogenated starch | 0.8 |
| Xanthan gum | 0.3 |
| Carbon dioxide | 0.15 |
| Methylparaben | 0.1 |
| Purified water | Remainder |

The gel had a viscosity of 160 dPa·s (20° C.), an ORP of 471 mV, and a pH of 4.88. 100 g of the gel was placed in a beaker, in which 0.2 g of a powder having a particle diameter of 1 mm or less prepared by pulverizing the hydrogen generating agent B prepared in Example 1 was dissolved under stirring with a spoon. After a lapse of about 10 minutes, the ORP and pH of the gel were measured; the ORP was 27 mV, and the pH was 6.08.

### EXAMPLE 7

A stock solution for producing a face pack gel containing dissolved carbon dioxide was prepared from the same ingredients as Example 6. At a temperature of 25° C., the stock solution had a viscosity of 5 dPa·s, and methyl cellulose as the thickening agent was not dissolved but dispersed. A predetermined amount of the powder of the hydrogen generating agent B prepared in Example 6 was placed in an aluminum laminate bag, and 25 g of the stock solution for producing a gel was injected from the top of the bag, and the bag was sealed with a heat sealer. The bag was allowed to stand at room temperature for about a half day, kneaded by hand to mix and dissolve the content, and then stored in a refrigerator overnight. During this time, the methyl cellulose in the stock solution was dissolved and thickened, and thus a gel containing dissolved carbon dioxide having reducibility and a viscosity of 160 dPa·s (20° C.) was obtained. The loading of the hydrogen generating agent B and the ORP and pH of the obtained gel are summarized in Table 5.

### [Table 5]

TABLE 5
Loading of hydrogen generating agent B, and ORP
and pH of gel

| Hydrogen | | | |
|---|---|---|---|
| generating | Loading | | |
| agent | (CaH2) | ORP | |
| (g) | (mg/L) | (mv) | pH |
| 0.1 | 5 | −198 | 5.07 |
| 0.2 | 10 | −317 | 5.24 |
| 0.4 | 20 | −343 | 6.82 |

### EXAMPLE 8

A Hydrogen generating agent D comprising PEG/anhydrous sodiumsulfate/LiH=10 g/10 g/0.2 g was prepared by a melt embedding method. The powders of sodiumsulfate and LiH were dispersed in PEG matrix in this hydrogen generating agent. The weighed amount of the hydrogen generating agent was put into the 500 ml PET bottle containing 500 ml purified water and the bottle was sealed. The hydrogen generating agent sank at first in the water, then it floated with generating hydrogen and dissolved in a few minutes. After dissolved, ORP and pH of the water were measured and the results were presented in Table 6. In the Table amount of LiH added to the water were reduced to that added to 1 L water.

### [Table 6]

TABLE 6
The amount of hydrogen generating agent D added
and ORP, pH (Purified water).

| Hydrogen | | | |
|---|---|---|---|
| generating agent | LiH | ORP | |
| (g) | (mg/L) | (mv) | pH |
| 0 (purified | 0 | 563 | 6.00 |
| water) | | | |
| 0.064 | 1.26 | 220 | 10.54 |
| 0.127 | 2.52 | 201 | 10.80 |
| 0.320 | 6.30 | 110 | 11.31 |
| 0.640 | 12.50 | 57 | 11.70 |
| 1.280 | 25.20 | −42 | 11.92 |

### EXAMPLE 9

A predetermined amount of an acid was added to a mixture of 10 g of PEG and 0.5 g of CaH₂, and acid-containing hydrogen generating agents E and F were prepared by the melting embedding method. The hydrogen generating agents composed of a powdery acid and CaH₂ embedded in PEG. The acids contained in the hydrogen generating agents E and F were anhydrous citric acid and L-ascorbic acid, respectively. 500 ml of tap water was placed in a 500-ml PET bottle, the hydrogen generating agent was added into the bottle in an amount to provide 50 mg of CaH₂, and the bottle was closed tightly. The respective hydrogen generating agents dissolved in several minutes while generating hydrogen. The ORP and pH of the obtained reducing water and the acid-free hydrogen generating agent B are summarized in Table 7. The ORP of the hydrogen generating agent containing L-ascorbic acid was very low. L-ascorbic acid was dissolved alone in purified water at a ratio of 0.5 g/L to make an aqueous solution. The ORP and pH of the solution were 495 mv and 3.30, respectively. These values were in linear relationship with the ORP and pH of purified water whose pH had been changed with hydrochloric acid or caustic soda.

### [Table 7]

TABLE 7
hydrogen generating agents E and F, and ORP and
pH of tap water

| Hydrogen | | Loading of | | |
|---|---|---|---|---|
| generating | | acid | ORP | |
| agent | Acid | (g) | (mv) | pH |
| None | — | — | 797 | 7.05 |
| (tap water) | | | | |
| B | — | 0 | −57 | 12.47 |
| E-1 | Citric | 1.53 | 268 | 5.63 |
| | acid | | | |
| E-2 | Citric | 2.29 | 276 | 4.55 |
| | acid | | | |
| F-1 | L-ascorbic | 2.10 | −626 | 11.78 |
| | acid | | | |
| F-2 | L-ascorbic | 3.14 | −538 | 10.01 |
| | acid | | | |
| F-3 | L-ascorbic | 3.56 | −440 | 8.48 |
| | acid | | | |
| F-4 | L-ascorbic | 4.19 | −320 | 6.01 |
| | acid | | | |
| F-5 | L-ascorbic | 4.82 | −319 | 5.78 |
| | acid | | | |

### EXAMPLE 10

Acid containing hydrogen generating agent, G and H were prepared by melt embedding adding the weighed amount of acid to the composition of PEG/LiH=10 g/0.19 g. G contained anhydrous citric acid and H did L-ascorbic acid. Weighed amount of hydrogen generating agent containing 19 mg LiH was put into the 500 ml PET bottle containing 500 ml tap water and the bottle was sealed. Each hydrogen generating agent was dissolved in a few minutes with generating hydrogen. ORP and pH of the reduced water were presented in table 8 including the results of hydrogen generating agent D which did not contain acid.

### [Table 8]

TABLE 8
ORP and pH of hydrogen generating agent, G and
H (Tap water).

| Hydrogen | | Amount | | |
|---|---|---|---|---|
| generating | | of acid | ORP | |
| agent | Acid | (g) | (mv) | pH |
| None | — | — | 702 | 6.92 |
| (tap water) | | | | |
| D | — | 0 | −96 | 12.30 |
| G-1 | citric acid | 1.52 | −130 | 6.57 |
| G-2 | citric acid | 1.07 | −71 | 11.42 |
| H-1 | L-ascorbic acid | 4.19 | −198 | 5.07 |
| H-2 | L-ascorbic acid | 2.93 | −454 | 10.40 |

### EXAMPLE 11

A hydrogen generating agent composed of 10 g of PEG and 0.5 g of CaH₂ was prepared by the melting embedding method. Blocks of the hydrogen generating agent were pulverized to powder. 1.05 g of the powder (CaH₂ content: 50 mg) and predetermined amounts of powdery anhydrous citric acid and L-ascorbic acid were weighed and uniformly mixed in a beaker using a spoon. The obtained mixed powder was placed in a stainless steel cylindrical cylinder having a bottom and an inside diameter of 16 mm, and a stainless steel piston having an outside diameter equivalent to the inside diameter of the cylinder was inserted into the cylinder. The cylinder was mounted on a hydraulic press, and the piston was pressed under pressure of 5 ton/cm² thereby forming the mixed powder into cylindrical tablets.

The tablets of the hydrogen generating agents J, K and L prepared as described above were placed in a PET bottle containing 500 ml tap water in the same manner as Example 10. The tablets sank in water at first, dissolved while violently generating hydrogen, and then floated to the water surface and completely dissolved in several minutes. The ORP and pH of the reducing water after dissolution of the tablets are summarized in Table 9.

### [Table 9]

TABLE 9
hydrogen generating agent, and ORP and pH of tap
water

| | |
|---|---|
| Hydrogen | Acid |

| generating | Citric | L-ascorbic | ORP | |
|---|---|---|---|---|
| agent | acid | acid | (mv) | pH |
| J | 114 | 157 | −275 | 5.12 |
| K | 114 | 105 | −345 | 6.60 |
| L | 77 | 157 | −422 | 7.60 |

### EXAMPLE 12

Hydrogen generating agents Mg-1 composed of 10 g of PEG and 0.313 g of MgH₂, and Mg-2 composed of 10 g of PEG, 0.313 g of MgH₂ and 1.40 g of succinic acid were prepared by the melting embedding method 1.03 g of the blocks of the hydrogen generating agent Mg-1 and 1.17 g of the blocks of Mg-2 (each of them contained 31.3 mg of MgH₂) were placed in a 500-ml PET bottle, 500 ml of purified water was injected therein, and the bottle was tightly closed. The hydrogen generating agents dissolved while moderately generating a hydrogen gas. The ORP and pH of the purified water after completion of the generation of hydrogen gas were measured; The ORP and pH obtained with Mg-1 were 43 mv and 10.87, and with Mg-2 were 32 mv and 5-19, respectively.

### EXAMPLE 13

CaH₂, 125 mg was mixed uniformly with sodium bicarbonate (8.0 g), fumaric acid (6.45 g) which evolved carbondioxide and a powder or granule of water soluble polymer (2.4 g) as water soluble components. In order to obtain tablet for bathing, the HGM of tablet type was formed by pressing the mixture as the same method mentioned in example 11. In the case of tablet for bathing, cylinder having 28 mm inner diameter and piston were used. The tablet for bathing which did not contain CaH₂ but evolved carbondioxide was prepared by the same method from sodium bicarbonate (8.0 g) and fumaric acid (6.1 g) for comparison (carbonic acid tablet for bathing).

The tablet for bathing was put in the plastic bucket contained 20 L tap water adjusted at 40 centigrade. The tablet sank at the bottom of bucket and dissolved evolving many small bubbles. After the complete dissolution (stop of bubble evolution), pH and ORP of the water were measured. The results were presented in table 10 together with the data of carbonic acid tablet for comparison. The content of CaH₂ in the tablet corresponded to 6.25 (mg/l, water). The pH and ORP of tap water were 6.91 and 828 mv before dissolving the tablet. It was found that the HGM disclosed here was useful for the reducing tablet in bathing.

### [Table 10]

TABLE 10
Properties of reducing tablet for bathing.

| Kind of water | | ORP | Bubbling time |
|---|---|---|---|
| soluble polymer | pH | (mv) | (sec.) |
| None(carbonic acid | 5.65 | 840 | 210 |
| tablet for bathing) | | | |
| None | 5.82 | 335 | 62 |
| PEG (foot-notes 1) | 5.50 | 218 | 409 |
| Methyl cellulose | 5.45 | 210 | 442 |
| (foot-notes 2) | | | |
| Carboxymethyl | 5.55 | 286 | 90 |
| Cellulose Sodium | | | |
| Poval (foot-notes 3) | 5.53 | 245 | 840 |

1) Molecular weight = 20000,
2) Wako Pure Chemical Industries Ltd. 400 cP
3) JAPAN VAM & POVAL CO., LTD. Grade JP-05

### EXAMPLE 14

A hydrogen generating agent composed of 4 g of PEG, 6 g of anhydrous sodium sulfate and 0.2 g of CaH₂ was prepared by the melting embedding method, and used as a bath agent. Tap water was placed in a bathtub to prepare 150 L of hot water at 42° C., and 4 pieces of the bath agent were put into the hot water (one piece was halved to make a total of 8 pieces, and the concentration of CaH₂ during bathing was 5.3 mg/L). The bath agent sank to the bottom of the bathtub, and dissolved in about 6 minutes while generating fine bubbles of a hydrogen gas.

The pH and ORP of the bath water immediately after completion of dissolution of the bath agent were measured, and the results are summarized in Table 11. The measurement was continued for about 3.5 hours, and 3 adult men bathed during that time. The ORP changed little during that time and maintained reducibility, while the pH slightly decreased after every bathing.

### [Table 11]

TABLE 11
Properties of bath agent

| Sampling time of | | | ORP | |
|---|---|---|---|---|
| bath water | | pH | (mv) | Note |
| Before injection | | 7.45 | 743 | |
| of bath agent | | | | |
| Immediately after | | 9.94 | 81 | |
| dissolution of | | | | |
| bath agent | | | | |
| Time elapsed | 10 min | 9.88 | 71 | |
| after dissolution | 30 min | 9.98 | 88 | |
| of bath agent | 60 min | 9.98 | 74 | First man bathed |
| | 75 min | 9.86 | 73 | |
| | 140 min | 9.80 | 110 | Second man bathed |
| | 155 min | 9.67 | 112 | |
| | 200 min | 9.65 | 97 | Third man bathed |
| | 215 min | 9.49 | 93 | |

### EXAMPLE 15

A mixture composed of 18 g of PEG, 5 g of anhydrous sodium sulfate, 10.1 g of sodium tetraborate, 5.3 g of sodium carbonate and 1.0 g of CaH₂ was uniformly mixed with a PEG melt under stirring. The mixture was injected into a cylindrical die, and solidified by cooling, and thus an alkaline bath agent was obtained (melting embedding method). The sodium tetraborate and sodium carbonate were used as alkaline pH controlling agents.

The bath agent was injected into a domestic bathtub containing 140 L of tap water at 42° C. The bath agent dissolved in 5 minutes while generating bubbles. During that time, the bath agent floats to the water surface after a lapse of 3 minutes and a half. The bath water before and after dissolution of the bath agent was placed in 500 ml PET bottles, and the ORP and pH of the water were measured next day. The results are as follows.

Before injection of bath agent: ORP=401, pH=6.55

After injection of bath agent: ORP=161, pH=9.91

### EXAMPLE 16

Hydrogen generating agents SA and SB composed of 18 g of PEG and 2 g of NaBH₄ (abbreviated as SBH), and 19.8 g of PEG and 0.2 g of NaBH₄ were prepared by the melting embedding method. PEG was placed in a clay dish, molten by being heated on a hot plate at 90 to 100° C., and SBH was mixed with and embedded in the PEG. Carbon dioxide was dissolved in purified water to obtain carbonated water (pH: 4.48). Predetermined amounts of the respective hydrogen generating agents were added to 20 L of the carbonated water at room temperature (about 20° C.), and the generation time of a hydrogen gas (dissolution time of the hydrogen generating agent), and the pH and ORP of the carbonated water after the addition of the hydrogen generating agents were measured. The results are summarized in Table 12. For comparison, powdery SBH was added to carbonated water. The powder dissolved in several seconds while generating a hydrogen gas.

### [Table 12]

TABLE 12
Properties of hydrogen generating agents
(SBH system, melting embedding method)

| | | | | | Hydrogen |
|---|---|---|---|---|---|
| Hydrogen | | | | | generation |
| generating | Loading | | ORP | | time |
| agent | (g) | SBH (g) | (mv) | pH | (minutes) |
| None | — | — | 556 | 4.48 | — |
| (carbonated | | | | | |
| water) | | | | | |
| SA | 1.0 | 0.1 | −171 | 4.67 | 4.0 |
| SB | 10 | 0.1 | −209 | 4.45 | 9.7 |

### EXAMPLE 17

Hydrogen generating agents SC to SF composed of PEG, SBH and an acid at the following ratios were prepared by the melting embedding method in the same manner as Example 16. Predetermined amount of the respective hydrogen generating agents were injected into 20 L of purified water (20° C.), and the hydrogen generation time, pH and ORP were evaluated in the same manner as Example 16. The properties of the hydrogen generating agents are summarized in Table 13.

1) Hydrogen generating agent SC: PEG/SBH/fumaric acid=14.9 g/2 g/3.1 g
2) SD: PEG/SBH/fumaric acid=194.9 g/2 g/3.1 g
3) SE: PEG/SBH/L-ascorbic acid=28.7 g/2 g/9.3 g
4) SF: PEG/SBH/L-ascorbic acid=38.9 g/0.2 g/0.9 g

### [Table 13]

TABLE 13
Properties of hydrogen generating agents (acid-
containing SBH system, melting embedding method)

| | | | | | Hydrogen |
|---|---|---|---|---|---|
| Hydrogen | | | | | generation |
| generating | Loading | SBH | ORP | | time |
| agent | (g) | (g) | (mv) | pH | (minutes) |
| None | — | — | 452 | 6.89 | — |
| (purified | | | | | |
| water) | | | | | |
| SC | 1 | 0.1 | −126 | 6.63 | 2.2 |
| SD | 10 | 0.1 | −161 | 6.51 | 7.8 |
| SE | 1 | 0.05 | −67 | 6.85 | 1.7 |
| SF | 10 | 0.05 | −107 | 5.97 | 7.6 |

### EXAMPLE 18

Hydrogen generating agents SG to SJ were prepared by the melting embedding method from the following ingredients, wherein xylitol was the melting embedding agent in place of PEG. The melting and mixing temperature was controlled within a range from 80 to 110° C. according to the viscosity of the mixture.

1) SG: xylitol/SBH/fumaric acid=14.9 g/2.0 g/3.1 g
2) SH: xylitol/SBH/fumaric acid=19.5 g/0.2 g/0.31 g
3) SI: xylitol/SBH/sulfamic acid/anhydrous sodium sulfate=15.3 g/0.2 g/0.5 g/4 g
4) SJ: xylitol/SBH/boron oxide/anhydrous sodium sulfate=14 g/0.2 g/1.9 g/4 g

Predetermined amounts of the hydrogen generating agents SG and SH were added in 20 L of purified water at 20° C., and the hydrogen generating agents SI and SJ in 20 L of tap water at 40° C., and their properties were evaluated. The results are summarized in Table 14.

### [Table 14]

TABLE 14
Properties of hydrogen generating agents (acid-
containing SBH system, melting embedding method)

| | | | | | Hydrogen |
|---|---|---|---|---|---|
| Hydrogen | | | | | generation |
| generating | Loading | SBH | ORP | | time |
| agent | (g) | (g) | (mv) | pH | (minutes) |
| SG | 1 | 0.1 | −149 | 6.15 | 2.0 |
| SH | 10 | 0.1 | −191 | 6.18 | 8.0 |
| SI | 5 | 0.05 | 53 | 6.81 | 2.2 |
| SJ | 5 | 0.05 | 49 | 7.76 | 3.5 |

### EXAMPLE 19

The powder mixture of composition shown below was blended uniformly in a beaker. The hydrogen generating agents (SK˜SN) of tablet form were molded from the mixture by the compression mold machine in the same manner of example 13. The properties of these hydrogen generating agents were measured in the same manner of example 17 and shown in the Table 15.
1) Hydrogen generating agent SK: PEG/SBH/citric acid=14.6 g/2 g/3.4 g
2) SL: PEG/SBH/citric acid=19.5 g/0.2 g/0.3 g
3) SM: sorbitol/SBH/sulfamic acid=13 g/2 g/5 g
4) SN sorbitol/SBH/sulfamic acid=19.3 g/0.2 g/0.5 g

### [Table 15]

TABLE 15
Properties of hydrogen generating agents
(Composition of acid and SBH, compression mold method).

| Hydrogen | | | | | Hydrogen |
|---|---|---|---|---|---|
| generating | Loading | SBH | ORP | | generating |
| agent | (g) | (g) | (mv) | pH | time (min.) |
| SK | 1 | 0.1 | −153 | 6.34 | 1.1 |
| SL | 10 | 0.1 | −208 | 6.51 | 4.7 |
| SM | 1 | 0.1 | −103 | 7.79 | 2.7 |
| SN | 10 | 0.1 | −156 | 7.11 | 10.1 |

### EXAMPLE 20

10 g of the hydrogen generating agent SC and 50 g of the hydrogen generating agent SD prepared in Example 17 were respectively injected into a domestic bathtub containing 150 L of tap water at 42° C., and the ORP, pH and hydrogen generation time t of bathwater after dissolution of the agent were measured. The ORP and pH of the blank tap water were 651 mv and 7.24, respectively, and the ORP, pH and t after injection of the hydrogen generating agent SC were −16 mv, 6.96 and 1.1 minutes, and after injection of the hydrogen generating agent SD were −103 mv, 7.08 and 4.2 minutes, respectively.

### EXAMPLE 21

The following ingredients were dissolved in purified water, and carbon dioxide was dissolved in the solution to make a weakly acidic beauty essence.

Ingredients of beauty essence

| | |
|---|---|
| Glycerol | 3.0% |
| Pyrrolidone carboxylic acid-Na | 2.5 |
| Betaine | 1.5 |
| Ascorbic acid-PMG | 1.0 |
| Nicotinic acid amide | 1.0 |
| Collagen | 0.5 |
| Aloe vera extract | 0.2 |
| Mugwort extract | 0.2 |
| Methylparaben | 0.2 |
| Sodium hyaluronate | 0.1 |
| Xanthan gum | 0.07 |
| Glycyrrhizinic acid-2K | 0.05 |
| Carbonated water | Remainder |

0.1 g of the hydrogen generating agent SA and 1.0 g of the hydrogen generating agent SB prepared in Example 16 were respectively added and dissolved in 1 kg of the beauty essence to prepare a reducing beauty essence. The ORP and pH of the beauty essence before the addition of the hydrogen generating agent were 611 mv and 4.68, respectively, and those after the addition of the hydrogen generating agent SA were −6 mv and 4.75, after the addition of the hydrogen generating agent SB were −88 mv and 4.91, respectively.

### EXAMPLE 22

SBH, 50 mg was mixed uniformly with sodiumbicarbonate (8.0 g), fumaric acid (6.18 g) which evolved carbondioxide and a powder or granule of water soluble polymer (3.5 g) used in example 13 as water soluble components. The hydrogen generating agents of tablet type for bathing were molded from the mixture by the compression mould machine in the same manner of example 13. The tablet for bathing which did not contain SBH but evolved carbondioxide was prepared by the same method from sodium bicarbonate (8.0 g) and fumaric acid (6.1 g) for comparison (carbonic acid tablet for bathing). The tablet for bathing was put in the plastic bucket contained

20 L tap water adjusted at 40 centigrade. The tablet sank at the bottom of bucket and dissolved evolving many small bubbles. After the complete dissolution (stop of bubble evolution) pH and ORP of the water were measured. The results were presented in table 16 together with the data of carbonic acid tablet for comparison. The content of SBH in the tablet corresponded to 2.5 (mg/L water). The pH and ORP of tap water were 7.16 and 632 mv before dissolving the tablet.

### [Table 16]

TABLE 16
Properties of reducing tablet for bathing
(Hydrogen generating agent of SBH, compression mold
method).

| Kind of water | | ORP | Bubbling time |
|---|---|---|---|
| soluble polymer | pH | (mv) | (min.) |
| None(carbonic acid | 5.35 | 700 | 2.8 |
| tablet for bathing) | | | |
| None | 5.20 | 149 | 2.7 |
| PEG | 5.16 | 72 | 8.7 |
| Methyl cellulose | 5.18 | 109 | 6.0 |
| Carboxymethyl | 5.28 | 112 | 3.8 |
| Cellulose Sodium | | | |

### EXAMPLE 23

The hydrogen generating agent comprising of sorbitol/SBH/glutamic acid/anhydrous sodiumsulfate=15.4 g/0.2 g/0.4 g/4 g was molded by compression mold method in the same manner as example 13. The hydrogen generating agent, 5 g was put in 20 L tap water adjusted at 40 centigrade. The evolution time of hydrogen t, ORP and pH of the water were measured. The results were that ORP=21 mv, pH=6.02 and t=6.8 minutes.

### EXAMPLE 24

Hydrogen generating agents of tablet form which contained LiBH₄, SH, KBH₄ as borohydride metal salt were molded from the mixture of composition shown below by the compression mold machine in the same manner of example 13.
1) PEG/LiBH₄/succinic acid/anhydrous sodiumsulfate=5 g/0.5 g/1.42 g/3.5 g
2) PEG/SBH/succinic acid/anhydrous sodiumsulfate=5 g/0.5 g/0.82 g/3.5 g
3) PEG/KBH₄/succinic acid/anhydrous sodiumsulfate=5 g/0.5 g/0.57 g/3.5 g

The weighed amount of hydrogen generating agent was put in 20 L tap water adjusted at 40 centigrade. The evolution time of hydrogen t, ORP and pH of the water were measured. The results were shown in Table 17.

### [Table 17]

TABLE 17
Properties of hydrogen generating agents (Kind
of hydrogen compounds, compression mold method).

| Hydrogen | Added amount | ORP | | H2 evolution |
|---|---|---|---|---|
| compound | (g) | (mv) | pH | time(min.) |
| LiBH4 | 1.05 | −186 | 7.14 | 1.6 |
| SBH | 0.99 | −119 | 7.28 | 2.1 |
| KBH4 | 0.95 | −27 | 7.29 | 1.8 |

### EXAMPLE 25

The hydrogen generating agents containing LiH, CaH₂, MgH₂ and SBH at the following ratios were prepared by the melting embedding method.

1) PEG/LiH/anhydrous sodium sulfate=10 g/0.2 g/6 g
2) PEG/CaH₂/anhydrous sodium sulfate=10 g/0.5 g/6 g
3) PEG/MgH₂/succinic acid/anhydrous sodium sulfate=10 g/0.31 g/1.4 g/6 g
4) PEG/SBH (1)/succinic acid/anhydrous sodium sulfate=10 g/025 g/0.41 g/6 g

Another hydrogen generating agent containing SBH was formed by the compression molding method from the following ingredients.

5) PEG/SBH (2)/succinic acid=12.8 g/0.2 g/0.33 g

In the hydrogen generating agents containing succinic acid, succinic acid was added in an amount enough to neutralize the alkali generated by reaction with water. About 1 g of the blocks of the hydrogen generating agent was accurately weighed, and placed in a 500 ml PET bottle having a water inlet and a gas outlet. 50 ml of purified water was injected into the bottle from the water inlet, and the generated hydrogen gas was collected from the gas outlet into a graduated cylinder filled with water, and the amount of the gas was measured. After completion of the generation of the hydrogen gas, the pH and ORP of the purified water in the PET bottle was measured. The results are summarized in Table 18. The yield of hydrogen from 1 g of the hydrogen generating agent was almost the same as the theoretical value estimated from the chemical reaction formula between each of the hydrogen compounds and water.

### [Table 18]

TABLE 18
Hydrogen gas yield from hydrogen generating
agent

| | | |
|---|---|---|
| Hydrogen | | |
| compound in | | Property of water |
| hydrogen | | after dissolution |
| generating | H₂ gas yield | of Y |

| agent (Y) | (ml/1 g of Y) | pH | ORP(mv) |
|---|---|---|---|
| LiH | 44.2 | 12.47 | 16 |
| CaH2 | 36.4 | 12.60 | 28 |
| MgH2 | 25.5 | 5.41 | −150 |
| SBH (1) | 34.8 | 5.84 | −111 |
| SBH (2) | 39.7 | 7.11 | −124 |

### EXAMPLE 26

The blocks of the hydrogen generating agent containing MgH₂ and SBH (1) prepared by the melting embedding method in Example 25 were pulverized with a mill to obtain a powder passing through a 0.75 mm screen. The powdery hydrogen generating agent containing 50 mg each of MgH₂ and SBH (1) was injected in a 500 ml PET bottle in the same manner as Example 25, 100 ml of purified water was injected into the bottle, and the reaction period with water and the yield of hydrogen were measured. For comparison, 50 mg of MgH₂ and SBH reagent powders was weighed, and the hydrogen yield and others were measured in the same manner.

In the test with the reagents, succinic acid was added to the purified water to be injected in an amount enough to neutralize the base to be generated thereby making acidic water. The water had a pH of 2.95 (MgH₂) or 3.20 (SBH). The results are summarized in Table 19. These results indicate that the hydrogen generating agent of the present invention completes reaction within a shorter time than the direct reaction between the MgH₂ reagent and acidic water. During weighing the samples, the hydrogen generating agent and the MgH₂ reagent were dry and easy to handle, but the SBH reagent was hard to handle because of its moisture absorption properties.

### [Table 19]

TABLE 19
Reaction time of water with powdery hydrogen
generating agent or reagent and hydrogen yield

| | Reaction | Hydrogen | pH of the |
|---|---|---|---|
| Hydrogen | time | yield | solution after |
| compound | (minutes) | (ml) | reaction |
| MgH₂ (Hydrogen | 11 | 72 | — |
| generating agent) | 30 | 72 | 5.71 |
| MgH₂ (Reagent) | 11 | 62 | — |
| | 30 | 70 | 5.57 |
| SBH (Hydrogen | 3 | 115 | — |
| generating agent) | 10 | 115 | 6.30 |
| SBH (Reagent) | 3 | 116 | — |
| | 10 | 116 | 5.93 |

### INDUSTRIAL APPLICABILITY

The hydrogen generating agent of the present invention dissolves in and impart reducibility to an aqueous composition such as a skin lotion, bath agent, or beverage. Therefore, the hydrogen generating agent is useful as a skin care product or health food. In addition, the hydrogen generating agent reacts with water to generate high purity hydrogen, so that it is useful as a fuel for fuel cells.

1.-8. (canceled)

9. A hydrogen generating agent comprising at least one hydrogen compound selected from the group consisting of alkali earth metal hydrides and metal borohydride salts embedded in a water-soluble compound selected from the group consisting of a polyethylene glycol, xylitol and trehalose.

10. The hydrogen generating agent according to claim 9, which include from 0.1 to 50% by mass of the hydrogen compound, based on total 100% by mass of the hydrogen compound and the water-soluble compound.

11. The hydrogen generating agent according to claim 9, wherein the water-soluble compound is the polyethylene glycol having a molecular weight of 1000 to 20000.

12. The hydrogen generating agent according to claim 9, wherein the water-soluble compound contains an acid.

13. The hydrogen generating agent according to claim 9, wherein the agent is in the form of powders.

14. The hydrogen generating agent according to claim 9, wherein the agent is in the form of tablets.

15. A process for preparing a hydrogen generating agent, comprising the steps of: mixing and dispersing at least one hydrogen compound selected from the group consisting of alkali earth metal hydrides and metal borohydride salts in a melt of a water-soluble compound by heating, and subsequently cooling the mixture to solidify.

16. The process according to claim 15, wherein the water-soluble compound is selected from the group consisting of a polyethylene glycol, xylitol and trehalose.

17. The process according to claim 15, wherein the water-soluble compound is the polyethylene glycol having a molecular weight of 1000 to 20000.

18. The process according to claim 15, wherein the water-soluble compound contains an acid.

19. The process according to claim 15, wherein the water-soluble compound are heated to melt at a temperature from 80 to 125° C.

20. The process according to claim 15, wherein the hydrogen generating agent is mixed with and dispersed uniformly in a melt of a water-soluble compound by heating, and subsequently the mixture is cooled to solidify.

21. The process according to claim 15, wherein after the mixture is extruded, the mixture is cooled to solidify, and then is formed into pellet.

22. The process according to claim 15, which include from 0.1 to 50% by mass of the hydrogen compound, based on total 100% by mass of the hydrogen compound and the water-soluble compound.

23. The process according to claim 15, the mixture is pulverized, after the mixture is cooled to solidify.

24. The process according to claim 23, the mixture is formed into tablet, after the mixture is pulverized.

25. The process according to claim 24, the mixture is formed into tablet, after the mixture is pulverized, added other powdery water-soluble compound.

26. A process for preparing reducing water or a reducing aqueous composition, wherein the hydrogen generating agent prepared by the process according to claim 15 is dissolved in water or an aqueous composition.

27. A process for using the hydrogen generating agent according to claim 9 as a bath agent, wherein the hydrogen generating agent is injected into a bathtub and dissolved therein.

28. A method for generating hydrogen, comprising reacting the hydrogen generating agent according to claim 9 with water or an aqueous composition to generate hydrogen.
